(19) United States
(12) Patent Application Publication
(10) Pub. No.: US 2007/0188024 A1
(43) Pub. Date: Aug. 16, 2007

(54) Switch device and input device using the same

(76) Inventors: Hitokazu Shitanaka, Fukui (JP); Masaki Kontani, Fukui (JP)

Correspondence Address: WENDEROTH, LIND & PONACK L.L.P., 2033 K. STREET, NW, SUITE 800, WASHINGTON, DC, 20006, US

(21) Appl. No.: 11/703,252

(22) Filed: Feb. 7, 2007

(30) Foreign Application Priority Data
Feb. 10, 2006 (JP) 2006-033376

(51) Int. Cl. B60L 1/00

(52) U.S. Cl. 307/10.1

(57) ABSTRACT

The switch device disclosed includes: a substantially disk-shaped operator; a substantially ring-shaped indicator provided between the operator and the light emitting elements disposed below the operator; and a visible portion formed in the center of an inner periphery of the operator. Since the indicator carrying indications of equipment functions in characters, symbols, figures or the like is formed separately from the operator, the indications will never turn sideways or upside down owing to the rotation of the operator.

### FIELD OF THE INVENTION

The present invention relates to a switch device chiefly used to operate an air-conditioner, audio equipment or the like in a vehicle and an input device using the same.

### BACKGROUND OF THE INVENTION

In recent years, a growing number of vehicles have been equipped with a lighted switch device, disposed on a front panel in vehicle interior, with various styles of operators to operate various kinds of electronic equipment such as air-conditioner or audio equipment. Japanese Patent Unexamined Publication No. 2005-216798 discloses such a lighted switch device.

A conventional switch device and an input device using the same are described with reference to FIGS. 4 and 5. FIG. 4 shows a cross-sectional view of the conventional switch device and the input device using the same, and FIG. 5 shows an exploded perspective view of the conventional switch device and the input device using the same. The input device using the conventional switch device includes a substantially disk-shaped operator 210 formed from an insulating resin and indications 220 as shown in FIGS. 4 and 5. On the top surface of operator 210, indications 220 is applied by laser machining, co-injection molding or the like so as to expose predetermined forms of characters, symbols, figures or the like on a transparent or light colored translucent portion 212 surrounded by opaque portion 211 colored in black or the like.

Switch-element 230 with an upward projecting operation axis 231 includes a plurality of contacts (not shown) internally to perform electrical switching by rotating or vertical moving of operation axis 231. Operation axis 231 is fixed into cylindrical projection 213 projecting from the bottom surface of operator 210.

Wiring board 240 having a plurality of wiring patterns (not shown) on its top and bottom surfaces and substantially box-shaped case 250 formed from an insulating resin form the switch device. Case 250 covers switch-element 230 and light emitting elements 260 such as light emitting diodes mounted on the top surface of wiring board 240, and operator 210 projects rotatably and movably vertically out of cylindrical opening 251 formed in the center of case 250.

Controller 270 is formed on the top surface of wiring board 240 using electronic components such as micro-computers. Switch-element 230 and light emitting elements 260 are connected to controller 270 via the wiring patterns to form a conventional input device.

Such a conventional input device has been installed on the front panel or the like in vehicle interior and controller 270 is connected electrically to various kinds of electronic equipment such as air-conditioner or audio equipment and vehicle electronic circuits (not shown) via connectors or lead wires (not shown).

In the above configuration, upon rotating operator 210 clockwise or anti-clockwise, operation axis 231 fixed on the bottom surface of operator 210 rotates together to perform electrical switching of contacts in switch-element 230, thereby transmitting the signals from controller 270 to electronic devices or electronic circuits to control for instance the air-conditioning temperature.

Upon pressing operator 210 downward, operation axis 231 is caused pressed to perform electrical switching of contacts in switch-element 230, thereby changing the temperature setting mode for air-conditioning from automatic to manual.

Moreover, light emitting elements 260 turn on in a case when it is dark such as at night to illuminate operator 210 from below. Since the light past translucent portion 212 illuminates indications 220 on the upper surface, characters, symbols, figures or the like on indications 220 become visible so that operator 210 can be identified and operated easily even in the case when it is dark.

Namely, the switch device can operate various functions of electronic equipment such as air-conditioner by rotating or pressing downward operator 210 and can perform the operation easily with the aid of illuminated indications 220 on operator 210 even when it is dark.

As described above, however, since indications 220 in characters, symbols, figures or the like is formed integrally on the top surface of operator 210 in the input device using the conventional switch device, indications 220 rotates together with the rotation of operator 210, causing the indications to turn sideways or upside down. The problem is, therefore, that a driver is hard to view the indications until he/she becomes accustomed to the operation, which would cause operational errors easily.

### SUMMARY OF THE INVENTION

The switch device disclosed in the present invention comprises: a substantially disk-shaped operator; contacts to perform electrical switching by rotating of operation axis fixed on the bottom surface of the operator; and light emitting elements to illuminate the operator from below, wherein a substantially ring-shaped indicator is provided between the operator and the light emitting elements, and a visible portion is formed in the center of the operator.

Since the indicator carrying indications in characters, symbols, figures or the like to show equipment functions is formed separately from the operator, the configuration can provide a switch device easy to view and operate instead of turning the indications sideways or upside down in rotating of operator.

The input device disclosed in the present invention comprises: the switch device; and a controller connected to contacts of the switch device and light emitting elements, wherein the controller turns on-off the light emitting elements according to electrical switching of the contacts of the switch device.

The configuration can realize the input device easy to view and operate.

### BRIEF DESCRIPTION OF THE DRAWINGS

FIG. 1 shows a cross-sectional view of a switch device and an input device using the same in accordance with an exemplary embodiment of the present invention.

FIG. 2 shows an exploded perspective view of the switch device and the input device using the same in accordance with the exemplary embodiment of the present invention.

FIG. 3A shows a plan view of the switch device and the input device using the same in accordance with the exemplary embodiment of the present invention.

FIG. 3B shows a plan view of the switch device and the input device using the same in accordance with the exemplary embodiment of the present invention.

FIG. 4 shows a cross-sectional view of a conventional switch device and the input device using the same.

FIG. 5 shows an exploded perspective view of the conventional switch device and the input device using the same.

### DETAILED DESCRIPTION OF THE INVENTION

The exemplary embodiment of the present invention is described next with reference to the drawings.

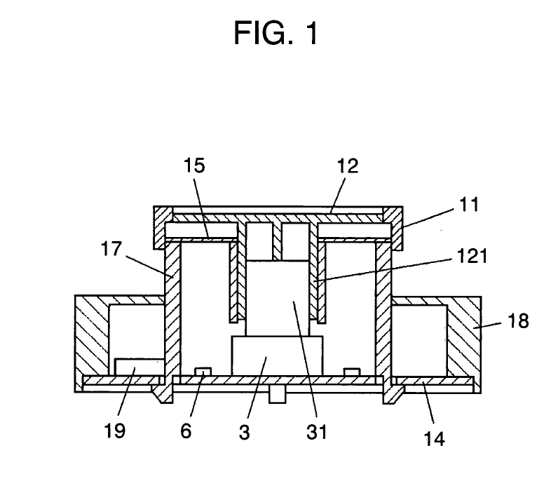

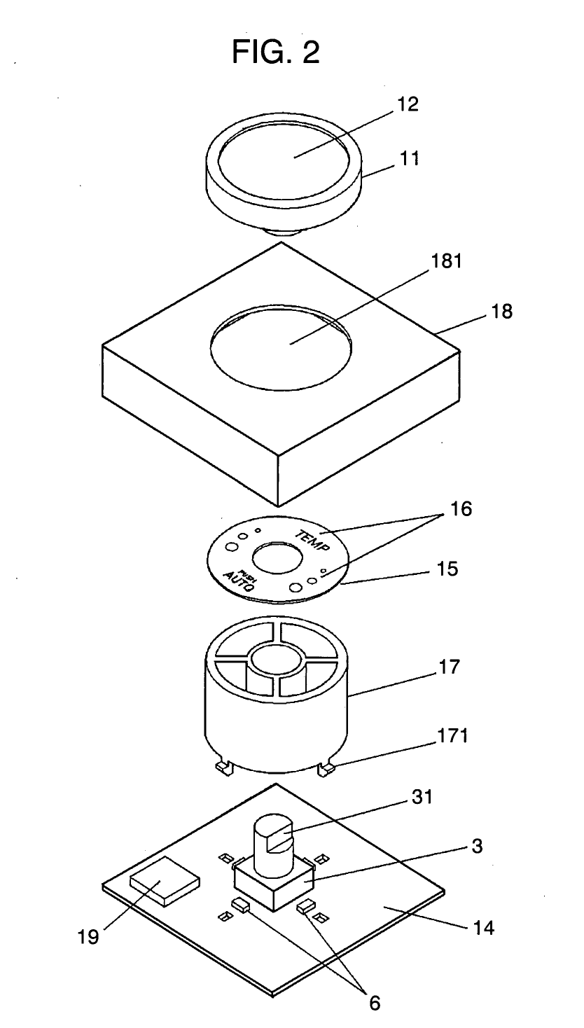

FIG. 1 shows a cross-sectional view of a switch device and an input device using the same used in exemplary embodiment of the present invention, and FIG. 2 shows an exploded perspective view of the switch device and the input device using the same shown in FIG. 1. The input device using the switch device, as shown in FIGS. 1 and 2, includes substantially disk-shaped operator 11 formed from opaque insulating resin colored in black or the like such as acrylic resin or polycarbonate resin. A translucent smoky visible portion 12, though dark colored such as in black or brown, is formed in the center of an inner periphery of operator 11. Operator 11 and visible portion 12 are formed integrally by co-injection molding or the like.

Switch-element 3 with an upward projecting operation axis 31 includes a plurality of contacts (not shown) internally to perform electrical switching by rotating or vertical moving of operation axis 31. Operation axis 31 is secured into cylinder 121 projecting from the bottom surface of operator 11.

On the top and bottom surfaces of wiring board 14 formed from phenolic paper, glass-reinforced epoxy or the like, a plurality of wiring patterns (not shown) are formed by using copper foil or the like, and switch-element 3 and a plurality of light emitting elements 6 such as LEDs are mounted on the top surface of wiring board 14.

On substantially ring-shaped indicator 15 formed from insulating resin, a plurality of indications 16 in characters, symbols, figures or the like are applied on the top or bottom surface of the translucent material colored in transparent, light color or the like, leaving the other area opaque in black or the like.

Substantially cylindrical cover 17 formed from insulating resin such as ABS resin or polyoxymethylene resin is secured on wiring board 14 by using hook 171 provided on the bottom surface and indicator 15 is attached on the top of cover 17 so that indicator 15 is disposed between operator 11 and light emitting elements 6. That is, light emitting elements 6 are disposed so as to illuminate operator 11 from below.

Substantially box-shaped case 18 formed from insulating resin is provided to cover the top surface of wiring board 14, allowing cover 17 to pass through opening 181 in the center of case 18, and operator 11 to fix on the top surface of cover 17 rotatably and movably vertically to complete the switch device configuration.

Controller 19 composed of electronic components such as micro-computers is provided on the top surface of wiring board 14. The contacts inside switch-element 3 or light emitting elements 6 are connected to controller 19 via wiring patterns to complete the input device configuration.

Such an input device is installed on a front panel or the like in vehicle interior and controller 19 is connected electrically to various kinds of electronic equipment such as air-conditioner or audio equipment and vehicle electronic circuits (not shown) via connectors or lead wires (not shown).

In the above configuration, rotating operator 11 clockwise or anti-clockwise will rotate operation axis 31 fixed on the bottom surface of operator 11 to perform electrical switching of contacts in switch-element 3. Controller 19 turns on-off light emitting elements 6 according to electrical switching of the contacts. The signals will be output from controller 19 to electronic devices or electronic circuits in order to for instance raise or lower the air-conditioning temperature.

Pressing operator 11 downward will press operation axis 31 down to perform electrical switching of contacts in switch-element 3, allowing controller 19 to change for instance temperature setting mode of air-conditioning from automatic to manual.

Moreover, light emitting elements 6 turn on in a case when it is dark such as at night and the light past cover 17 illuminates indicator 15 from below. Therefore, indications 16 in characters, symbols, figures or the like can be identified clearly through visible portion 12 of operator 11. Consequently, a driver can identify and operate operator 11 easily even when it is dark.

Additionally, since indicator 15 carrying indications in characters, symbols, figures or the like to show equipment functions is attached on the top of cover 17 separately from operator 11, the indications will never turn sideways or upside down in the rotation of operator 11, and will be identified easily without any operational error.

Since visible portion 12 provided in the center of the inner periphery of operator 11 is formed in a translucent smoky dark color, the switch device can perform a wide variety of illuminating modes such that indications 16 on indicator 15 below operator 11 can be made hard to identify from above when it is light and no illumination of light emitting elements 6, and indications 16 can be identified clearly only when light emitting elements 6 turn on for illumination.

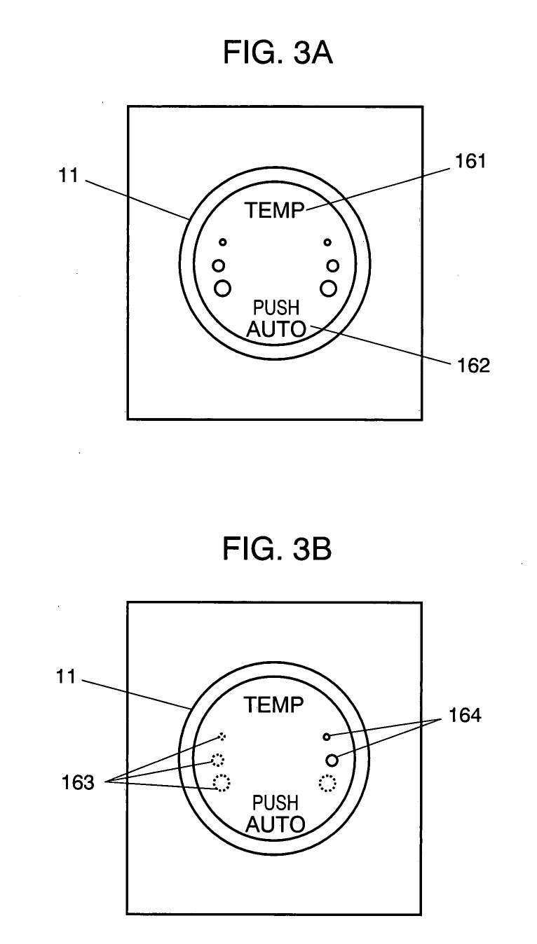

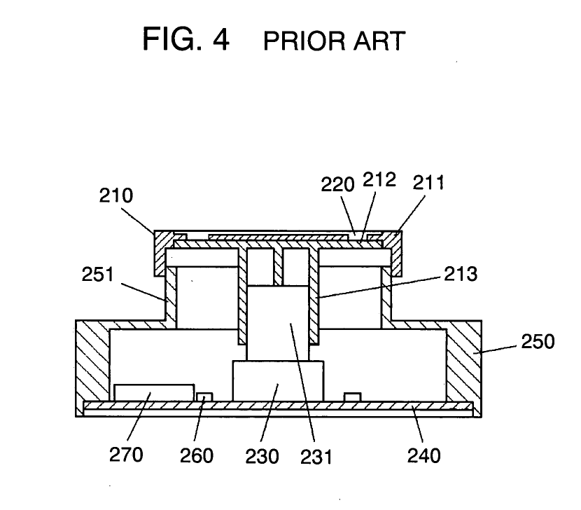

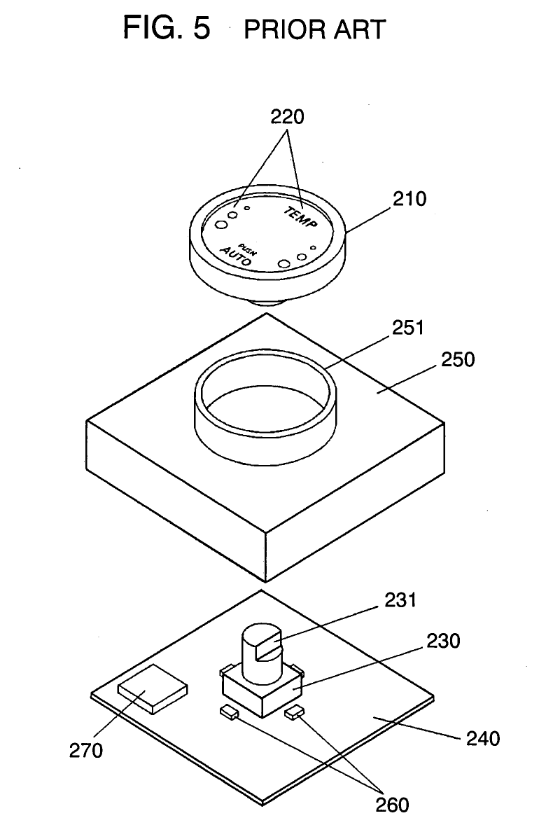

Also upon pressing operator 11, if controller 19 is set for instance, as shown in the plan view in FIG. 3A, to turn always-on the upper side indications 161 and to turn off the downside indications 162 when the air-conditioning temperature is in an automatic mode according to electrical switching of switch-element 3, and to turn on downside indications 162 when the mode is changed to an manual mode by pressing down operator 11, whether the air-conditioning is controlled automatically or manually can be recognized easily and the configuration will be able to perform an easier operation in wider variety.

Moreover, if light emitting elements 6 corresponding to the number and color of respective indications are disposed on wiring board below right-and-left indications 163 and 164, and controller 19 is set, for instance to raise air-conditioning temperature, as shown in FIG. 3B, to turn off left-hand side cold color indications 163 and to turn on right-hand side warm color indications 164 corresponding amounts of the rotation by rotating operator 11 clockwise or ant-clockwise, how much degree the switch device has operated to raise the temperature can be recognized at once and the configuration will be able to perform an easier operation.

As described above in the exemplary embodiment, the switch device disclosed includes: substantially disk-shaped operator 11; substantially ring-shaped indicator 15 provided between operator 11 and light emitting elements 6 disposed below operator 11; and visible portion 12 formed in the center of the inner periphery of operator 11. Since indicator 15 carrying characters, symbols, figures or the like to indicate equipment functions is formed separately from operator 11, the indications on indicator 15 will never turn sideways or upside down in the rotation of operator 11. The present invention, therefore, can provide the switch device easy to view and operate.

Since visible portion 12 on operator 11 is formed in a translucent smoky dark color, the switch device can perform a wide variety of illuminating modes such that the indications become hard to view when it is light and become visible clearly only when indicator 15 is illuminated.

The input device easy to view and operate with a wide variety of applications can be realized by connecting controller 19 to the switch device to turn on-off light emitting elements 6 according to electrical switching of the contacts of the switch device.

In the above configuration, switch-element 3 with substantially cylindrical operation axis 31 projecting upward in the center is described used as contacts for electrical switching by rotating and vertical moving of operator 11, but a large diameter hollow cylinder can replace operation axis 31 or a combination of rotary switch and pressing switch can be acceptable to realize the present invention.

What is claimed is:

1. A switch device comprising:
a substantially disk-shaped operator;
a contact to switch on-off electrically by rotating of an operation axis fixed on a bottom surface of the operator; and
a light emitting element to illuminate the operator from below,
wherein a substantially ring-shaped indicator is provided between the operator and the light emitting element, and a visible portion is provided in a center of an inner periphery of the operator.

2. The switch device of claim 1, wherein the visible portion of the operator is formed in a dark color.

3. An input device comprising:
a switch device including;
a substantially disk-shaped operator;
a contact to switch on-off electrically by rotating of an operation axis fixed on a bottom surface of the operator; and
a light emitting element to illuminate the operator from below,
wherein a substantially ring-shaped indicator is provided between the operator and the light emitting element, and a visible portion is provided in a center of an inner periphery of the operator; and
a controller connected to the contact of the switch device and the light emitting element,
wherein the controller turns on-off the light emitting element according to electrical switching of the contact.
